(19) United States
(12) Patent Application Publication
(10) Pub. No.: US 2025/0357765 A1
(43) Pub. Date: Nov. 20, 2025

(54) POWER OVER DATA LINE (PODL) SYSTEM WITH ENERGY STORAGE

(71) Applicant: Microchip Technology Incorporated, Chandler, AZ (US)

(72) Inventor: Tobias Hampel, Karlsruhe (DE)

(73) Assignee: Microchip Technology Incorporated, Chandler, AZ (US)

(21) Appl. No.: 18/783,685

(22) Filed: Jul. 25, 2024

Related U.S. Application Data
(60) Provisional application No. 63/647,833, filed on May 15, 2024.

(51) Int. Cl. H02J 7/00; H02J 7/34

(52) U.S. Cl. CPC H02J 7/00032; H02J 7/00304; H02J 7/345; H02J 2207/50

(57) ABSTRACT

An apparatus includes a power/data decoupling circuitry connected to a data line carrying power and data, the power/data decoupling circuitry to decouple power from data carried on the data line, an application circuitry switchable between a sleep mode and an active mode, and an energy management system including an energy storage device connected between the power/data decoupling circuitry and the application circuitry. The energy management system includes circuitry to receive power from the power/data decoupling circuitry, and use the received power to (a) provide a continuous power supply to the application circuitry in at least the sleep mode of the application circuitry and (b) charge the energy storage device. The energy management system may further include circuitry to use energy stored in the energy storage device to provide a switchable power supply to the application circuitry in at least the active mode of the application circuitry.

### RELATED APPLICATION

This application claims priority to commonly owned U.S. Provisional Patent Application No. 63/647,833 filed May 15, 2024, the entire contents of which are hereby incorporated by reference for all purposes.

### TECHNICAL FIELD

The present disclosure relates to Power over Data Line (PoDL) systems, and more particularly, a PoDL system including energy storage.

### BACKGROUND

A wired network in which power and data are transmitted on the same lines is commonly referred to as a Power over Data Line (PoDL) network. A PoDL network includes coupling circuits to combine power and data signals on a common line (e.g., a wire pair), and decoupling circuits to decouple the data signals from power carried on the common line. In a conventional PoDL network, the coupling and decoupling circuits are designed for a maximum current needed by any applications (e.g., sensors, actuators, etc.) in the network. However, the higher the current, the larger and more expensive the components required. In addition, higher power transmitted on the network may negatively affect the signal quality of data carried on the common line. This commonly reduces the maximum number of nodes and the maximum effective cable length in a conventional multidrop PoDL network. In addition, rapid changes in current consumption can interfere with the data signals.

There is a need for an improved PoDL network, e.g., using reduced power levels.

### SUMMARY

The present disclosure provides an apparatus (e.g., corresponding with a powered node in a PoDL network) including an application circuitry (e.g., including a sensor, actuator, or other functional device) and circuitry for switching between (a) a sleep mode during which an energy storage device (e.g., a capacitor or battery) is charged and (b) an active mode during which the application circuitry is at least partially powered by the charged energy storage device to perform some defined function(s). In some examples, the apparatus may be intermittently awakened (switched to the active mode) for relatively short durations to perform defined function(s) requiring a higher current which may be at least partially provided by the charged energy storage device, and upon completion of such function(s), switched back to the sleep mode, during which the energy storage device is recharged. Thus, the apparatus may draw a relatively low current over time, which current is at least partially used to charge the energy storage device, wherein the charged energy storage device may power the device during active mode operation. Accordingly, a peak current drawn by the apparatus (e.g., from a PoDL line supplying power and data to the apparatus) over time may be reduced, e.g., as compared with a current needed for active mode operation of the apparatus.

Reducing the peak current drawn by the apparatus may provide various different advantages or benefits. For example, reducing the peak current may allow reduction and/or simplification of various components in the apparatus and/or a network in which the apparatus is connected. For example, power/data decoupling circuitry may be reduced or simplified. As another example, reducing the peak current may allow a reduction in the size and cost of a network power supply (e.g., PoDL power supply) used by the apparatus. As another example, reducing the peak current may allow reductions in wiring/cabling requirements (e.g., wire gauge) and unwanted heat generation. As another example, reducing the peak current may reduce power-related effects on (and thereby improve) the signal quality of data transmitted to and/or from the apparatus.

One aspect provides an apparatus including a power/data decoupling circuitry connected to a data line carrying power and data, the power/data decoupling circuitry to decouple power from data carried on the data line, an application circuitry switchable between a sleep mode and an active mode, and an energy management system including an energy storage device connected between the power/data decoupling circuitry and the application circuitry. The energy management system includes circuitry to receive power from the power/data decoupling circuitry, use the received power to (a) provide a continuous power supply to the application circuitry in at least the sleep mode of the application circuitry and (b) charge the energy storage device, and use energy stored in the energy storage device to provide a switchable power supply to the application circuitry in at least the active mode of the application circuitry.

In some examples, the energy management system includes a current limiter circuitry connected between the power/data decoupling circuitry and the energy storage device, the current limiter circuitry to limit a current drawn from the data line.

In some examples, a current output by the current limiter circuitry (a) supplies the continuous power supply to the application circuitry and (b) charges the energy storage device.

In some examples, the energy management system provides the continuous power supply to the application circuitry in both the sleep mode and the active mode of the application circuitry.

In some examples, the energy storage device comprises a capacitor or a battery.

In some examples, the apparatus includes control circuitry to selectively switch the application circuitry between the sleep mode and the active mode, enable the switchable power supply, provided by energy stored in the energy storage device, to the application circuitry for operation in the active mode of the application circuitry, and disable the switchable power supply from the application circuitry for operation in the sleep mode of the application circuitry.

In some examples, the control circuitry comprises a comparator to compare a charge level of the energy storage device with a threshold charge level, and based on the comparison, generate an activation signal to (a) switch the application circuitry from the sleep mode to the active mode and (b) enable the switchable power supply to the application circuitry.

In some examples, the control circuitry comprises a timer circuitry to generate a time-based activation signal to (a) switch the application circuitry from the sleep mode to the active mode and (b) enable the switchable power supply to the application circuitry.

In some examples, a current drawn from the data line by the energy management system is lower than a current used by the application circuitry in the active mode of the application circuitry.

In some examples, the application circuitry comprises an network controller and a functional device; in the sleep mode of the application circuitry, the network controller is powered by the continuous power supply, and the functional device is unpowered; and in the active mode of the application circuitry, the network controller and the functional device are powered by the switchable power supply from the energy storage device.

One aspect provides an apparatus including a power source device, and multiple powered devices connected to the power source device by a data line carrying power and data. A respective powered device of the multiple powered devices comprises a power/data decoupling circuitry to decouple power from data carried on the data line, an application circuitry switchable between a sleep mode and an active mode, and an energy management system including an energy storage device connected between the power/data decoupling circuitry and the application circuitry. The energy management system includes circuitry to receive power from the power/data decoupling circuitry, use the received power to (a) provide a continuous power supply to the application circuitry in at least the sleep mode of the application circuitry and (b) charge the energy storage device, and use energy stored in the energy storage device to provide a switchable power supply to the application circuitry in at least the active mode of the application circuitry.

In some examples, the energy management system of the respective powered device includes a current limiter circuitry connected between the power/data decoupling circuitry and the energy storage device, the current limiter circuitry to limit a current drawn from the data line.

In some examples, an output of the current limiter circuitry (a) supplies the continuous power supply to the application circuitry and (b) charges the energy storage device.

In some examples, the respective powered device includes control circuitry to selectively switch the application circuitry between the sleep mode and the active mode; enable the switchable power supply, provided by energy stored in the energy storage device, to the application circuitry for operation in the active mode of the application circuitry; and disable the switchable power supply from the application circuitry for operation in the sleep mode of the application circuitry.

In some examples, the control circuitry comprises a comparator to compare a charge level of the energy storage device with a threshold charge level, and based on the comparison, generate an activation signal to (a) switch the application circuitry from the sleep mode to the active mode and (b) enable the switchable power supply to the application circuitry.

In some examples, the control circuitry comprises a timer circuitry to generate a time-based activation signal to (a) switch the application circuitry from the sleep mode to the active mode and (b) enable the switchable power supply to the application circuitry.

One aspect provides a method, including operating a device including an application circuitry in a sleep mode, including receiving power from a data line carrying power and data and using the received power to (a) provide a continuous power supply to the application circuitry and (b) charge an energy storage device. The method includes switching the device from the sleep mode to an active mode, including enabling a switchable power supply, provided by energy stored in the energy storage device, to the application circuitry, and operating the device in the active mode, including using the switchable power supply to perform at least one function of the application circuitry.

In some examples, receiving power from a data line in the sleep mode comprises using a power/data decoupling circuitry to decouple power from data carried on the data line, and using a current limiter circuitry to limit a current drawn from the data line.

In some examples, the method includes switching the device from the active mode back to the sleep mode, including disabling the switchable power supply from the application circuitry.

In some examples, the method includes using a comparator circuitry to compare a charge level of the energy storage device with a threshold charge level, and based on the comparison, generate an activation signal to (a) switch the device from the sleep mode to the active mode and (b) enable the switchable power supply to the application circuitry.

In some examples, the method includes using a timer circuitry to generate a time-based activation signal to (a) switch the device from the sleep mode to the active mode and (b) enable the switchable power supply to the application circuitry.

### BRIEF DESCRIPTION OF THE DRAWINGS

Example aspects of the present disclosure are described below in conjunction with the figures, in which:

FIG. 1 shows an example apparatus (e.g., representing a PoDL network node) including an application circuitry switchable between a sleep mode and an active mode, and circuitry for storing energy and controllably supplying power to the application circuitry;

FIG. 2 shows another example apparatus (e.g., representing a PoDL network node) including an application circuitry switchable between sleep mode operation and active mode operation, and circuitry for controllably storing energy and supplying power to the application circuitry;

FIGS. 3A and 3B illustrate two example circuits for selectively enabling a switchable power supply comprising stored power to the application circuitry;

FIG. 4 shows another example apparatus (e.g., representing a PoDL network node) including an application circuitry switchable between sleep mode operation and active mode operation, and circuitry for controllably storing energy and supplying power to the application circuitry;

FIG. 5 shows an example PoDL network incorporating aspects of the present disclosure, e.g., including at least one network node represented by any of the example apparatuses shown in FIGS. 1-4; and

FIG. 6 shows a flowchart of an example method of operating a device (e.g., any of the example apparatuses shown in FIGS. 1-5) including switching between (a) a sleep mode during which an energy storage device is charged and (b) an active mode during which an application circuitry of the device is at least partially powered by the charged energy storage device.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

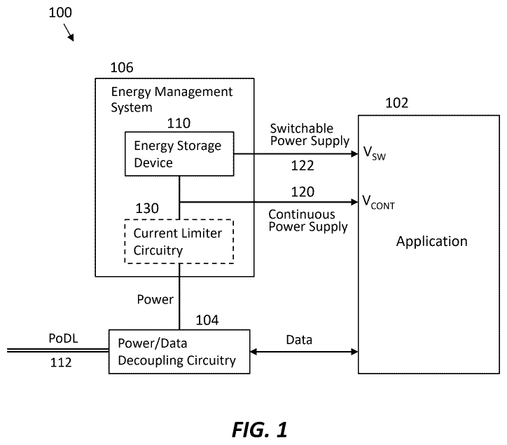

FIG. 1 shows an example apparatus 100 including an application circuitry 102 switchable between a sleep mode and an active mode, and circuitry for storing energy and controllably supplying power to the application circuitry 102. In some examples, the apparatus 100 may be a network node in a PoDL network. The example apparatus 100 may include the application circuitry 102, a power/data decoupling circuitry 104, and an energy management system 106 including an energy storage device 110 connected between the power/data decoupling circuitry 104 and the application circuitry 102. As discussed below, the energy management system 106 may charge the energy storage device 110 during sleep mode operation of the application circuitry 102, and use the charged energy storage device 110 to power the application circuitry 102 during active mode operation, to thereby reduce a current drawn by the apparatus 100 (e.g., from a PoDL power supply) at least during active mode operation, e.g., as compared with conventional systems.

In some examples, the apparatus 100 may be intermittently awakened (switched to the active mode) for relatively short durations to perform some defined function(s) requiring a higher current which may be at least partially provided by the charged energy storage device 110, and upon completion of such function(s), switched back to the sleep mode, during which the energy storage device 110 is recharged.

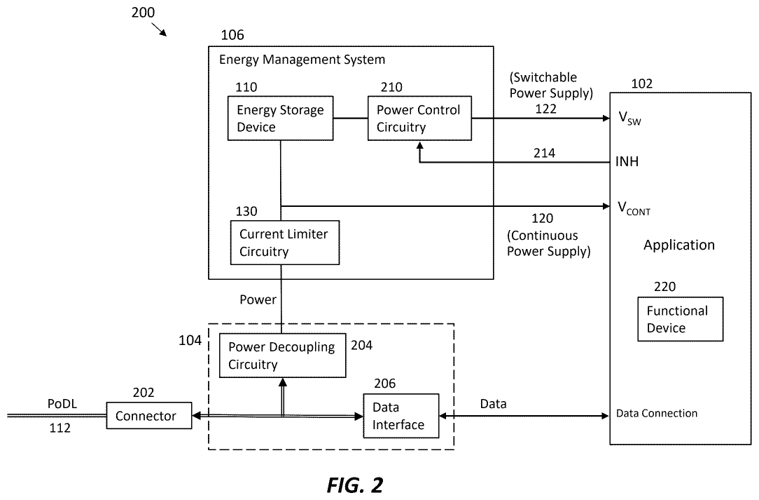

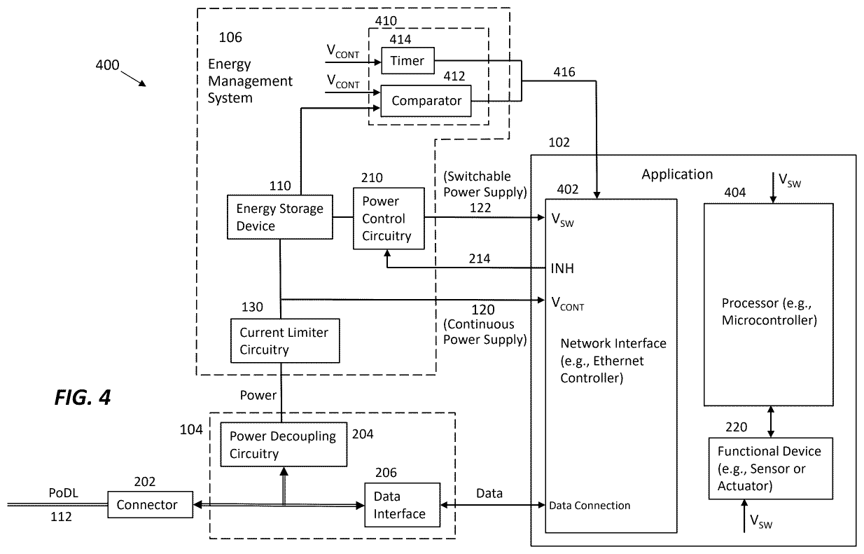

The application circuitry 102 may include a functional device to perform a specified function, for example a sensor to generate sensor data or an actuator to generate actuation signals. In some examples, e.g., as shown in FIGS. 2 and 4 discussed below, the application circuitry 102 may further include a network interface (e.g., an Ethernet controller) and a processor (e.g., embodied in a microcontroller) to manage the operation of the functional device (e.g., sensor or actuator).

As mentioned above, the application circuitry 102 is switchable between a sleep mode and an active mode. For example, the application circuitry 102 may comprise a functional device (e.g., sensor or actuator) that alternatingly switches between (a) a low-power sleep mode and (b) a higher-power active mode during which specified function(s) (e.g., sensor measurements or actuation signal generation) are performed. In examples in which the application circuitry 102 further includes a network interface (e.g., Ethernet controller) and a processor (e.g., microcontroller), the network interface and processor may also switch between the sleep mode and active mode.

The power/data decoupling circuitry 104 may be connected to a data line 112 carrying power and data, also referred to herein as a PoDL line 112. The power/data decoupling circuitry 104 may include circuitry to decouple power from data carried on the data line. For example, as shown in FIG. 1, power/data decoupling circuitry 104 may include (a) circuitry (e.g., including an inductor) to decouple power from data carried on the PoDL line 112 (e.g., by filtering or blocking data) and transmit the decoupled power to the energy management system 106, and (b) circuitry to decouple data from power carried on the PoDL line 112 (e.g., by filtering or blocking power) and transmit the decoupled data to the application circuitry 102. As used herein, decoupling power from the PoDL line 112 may include at least partially filtering or blocking data carried on the PoDL line 112, while decoupling data from the PoDL line 112 may include at least partially filtering or blocking power carried on the PoDL line 112.

The energy management system 106 may include circuitry to receive decoupled power from the power/data decoupling circuitry 104, and use the received power to (a) provide a continuous power supply 120 to the application circuitry 102 in at least the sleep mode of the application circuitry 102 and (b) charge the energy storage device 110. The energy management system 106 may use energy stored in the energy storage device 110 to provide a switchable power supply 122 to the application circuitry 102 in the active mode of the application circuitry 102. In some examples, the energy management system 106 provides the continuous power supply 120 to the application circuitry 102 in both the sleep mode and the active mode of the application circuitry 102, i.e., continuously.

The energy storage device 110 may comprise one or more capacitors, or one or more batteries.

In operation, during sleep mode operation of the application circuitry 102, the energy management system 106 powers the application circuitry 102 using the continuous power supply 120, while the switchable power supply 122 provided by the energy storage device 110 remains switched off (i.e., does not power the application circuitry 102). In other words, during sleep mode operation, the energy management system 106 uses the decoupled power transmitted by the power/data decoupling circuitry 104 (using current drawn from the PoDL line 112) to (a) provide the continuous power supply 120 powering the application circuitry 102 and (b) charge the energy storage device 110 for use during subsequent active mode operation.

For active mode operation of the application circuitry 102 (e.g., to perform respective sensor or actuator functions), the energy management system 106 switches on the switchable power supply 122 to power the application circuitry 102 (in some examples, together with the continuous power supply 120). In some examples, the energy management system 106 may continue (during active mode operation, similar to sleep mode operation) to use the decoupled power transmitted by the power/data decoupling circuitry 104 (using current drawn from the PoDL line 112) to (a) provide the continuous power supply 120 and (b) charge the energy storage device 110.

As shown in FIG. 1, the continuous power supply 120 may apply a voltage V_{cont} at application circuitry 102, and the switchable power supply 122 may apply a voltage V_{sw} at application circuitry 102. In some examples, the continuous power supply 120 (V_{cont}) is supplied to the application circuitry 102 continuously, during both sleep mode and active mode operation. In other examples, the continuous power supply 120 (V_{cont}) is supplied to the application circuitry 102 during sleep mode operation but not during active mode operation; in such examples the application circuitry 102 may be fully powered by the switchable power supply 122 (V_{sw}) during active mode operation.

By charging the energy storage device 110 during sleep mode operation, and using the charged energy storage device 110 (i.e., switchable power supply 122) to power the application circuitry 102 during active mode operation, a peak current drawn by apparatus 100 from PoDL line 112 over time may be reduced, e.g., as compared with conventional systems. The peak current drawn by apparatus 100 from PoDL line 112 over time, also referred to herein as a “peak PoDL current draw” or “Iₚₑₐₖ” may refer to a peak instantaneous current value drawn by apparatus 100 from PoDL line 112 during a period including multiple alternating instances of sleep mode operation and active mode operation.

In some examples, the energy management system 106 may optionally include current limiter circuitry 130 to limit a current drawn from the PoDL line 112, thereby defining the peak PoDL current draw (Iₚₑₐₖ), e.g., sufficient to provide the continuous power supply 120 and charge the energy storage device 110. In some examples, the current limiter circuitry 130 may include circuitry to output a constant current, e.g., Iₚₑₐₖ. In other examples, the current limiter circuitry 130 may include a resistor, which circuitry may output a current that varies as a function of the energy storage device 110 charge status. In other examples, the current limiter circuitry 130 may include more complex circuitry including components (e.g., transistors) to dynamically adjust the current limit.

In some examples, Iₚₑₐₖ defined by the current limiter circuitry 130 may be less than a current used by application circuitry 102 for active mode operation, I_{active} (i.e., the current provided by the switchable power supply 122). In some examples, Iₚₑₐₖ may be less than 50% of I_{active}, less than 10% of I_{active}, or less than 1% of I_{active}.

In some examples, the continuous power supply 120 may supply a significantly lower current than the switchable power supply 122, for example less than 10%, less than 1%, or less than 0.1% of the switchable power supply 122. For example, in an example implementation in which the application circuitry 102 includes an Ethernet controller, the continuous power supply 120 may be in the range of 10-50 μA, whereas the switchable power supply 122 (for active mode operation) may be in the range of 10-100 mA.

In addition, in some examples the continuous power supply 120 may comprise a relatively small fraction of the current drawn from PoDL line 112. In other words, a small fraction (e.g., less than 10%, less than 1%, or less than 0.1%) of the current drawn from PoDL line 112 (e.g., as defined by the current limiter circuitry 130) may provide the continuous power supply 120, while a remaining larger fraction (e.g., more than 90%, more than 99%, or more than 99.9%) of the current drawn from PoDL line 112 may be used to charge the energy storage device 110. For example, in an example implementation in which the current drawn from PoDL line 112 is maintained at 1 mA (e.g., by the current limiter circuitry 130), the continuous power supply 120 may supply 30 μA, while the remaining 970 μA may be used to charge the energy storage device 110.

In some examples, the peak PoDL current draw (Iₚₑₐₖ) may be set (e.g., by current limiter circuitry 130) as a function of the duty cycle of the application circuitry 102, wherein the higher duty cycle, the lower the Iₚₑₐₖ to power the application circuitry 102. For example, assume an example application circuitry 102 including a sensor, wherein respective instances of active mode operation have a duration of 10 ms from waking up to taking a sensor measurement and transmitting the sensor data, and use 50 mA to perform the relevant functions. And assume the sensor is configured to take a measurement every 1.0 second, i.e., the application circuitry 102 switches from sleep mode to active mode every 1.0 second and operates in the active mode for 10 ms before switching back to the sleep mode. Further assume a current limiter circuitry 130 that draws a constant current (Iₚₑₐₖ) of 1 mA at 12V, of which current 30 μA provides the continuous power supply 120 and the remaining 970 μA charges an energy storage device 110 comprising a 100 μF capacitor (i.e., the capacitor is charged by a constant current of 970 μA). In such arrangement the time to charge the energy storage device 110 could be calculated by the equation: t=12V*100 μF/970 μA=1.24 seconds. Thus, such example system could enter active mode operation to take a sessor measurement and transmit the sensor data every 1.24 seconds. Such active mode frequency is suitable for various types of functional device, for example, a typical ambient temperature sensor. The current drawn by the current limiter circuitry 130 may be adjusted based on the needed active mode frequency of the application circuitry 102.

In the example above, if a current limiter circuitry 130 comprising a resistor is used (instead of the example current limiter circuitry 130 that supplies a constant current of 970 μA to charge the energy storage device 110), the current supplied to the energy storage device 110 by current limiter circuitry 130 may decrease as a function of increasing charge (capacitance) of the energy storage device 110, which may increase the time to charge the energy storage device 110. For example, an example energy management system 106 implementing current limiter circuitry 130 comprising a 12 kΩ resistor may have a charging time of 5-6 seconds to fully charge (e.g., >99%) the 100 μF capacitor.

Reducing the peak PoDL current draw (Iₚₑₐₖ) of apparatus 100 (by storing energy in the energy storage device 110) may provide various benefits. For example, reducing Iₚₑₐₖ may allow reduction and/or simplification of components in the power/data decoupling circuitry 104 (of apparatus 100 and/or other network nodes). As another example, reducing Iₚₑₐₖ may reduce the current requirements of the relevant network power source, e.g., a Power Sourcing Equipment (PSE) node connected to the apparatus 100 in a PoDL network implementation. As another example, reducing Iₚₑₐₖ may allow reductions in wiring/cabling requirements and unwanted heat generation. As another example, reducing Iₚₑₐₖ may reduce power-related effects on (and thereby improve) the signal quality of data transmitted to the application circuitry 102.

In some examples, the size (capacity) of the energy storage device 110 may define the maximum duration of each instance of active mode operation of the application circuitry 102. In addition, the characteristics of the current limiter circuitry 130 and energy storage device 110 may collectively define a needed duration in the sleep mode to collect sufficient energy in the energy storage device 110 for operation in the active mode, and thereby define the duty cycle of the application circuitry 102.

FIG. 2 shows an example apparatus 200 including the application circuitry 102 switchable between a sleep mode and an active mode, and circuitry for controllably supplying power to the application circuitry 102. The example apparatus 200 may comprise an example implementation of the example apparatus 100 shown in FIG. 1 and discussed above. In some examples, the apparatus 200 may be a network node in a PoDL network.

As shown, the example apparatus 200 includes a connector 202, power/data decoupling circuitry 104, application circuitry 102, and energy management system 106.

The connector 202 may comprise any suitable connector device for connecting to PoDL line 112. The power/data decoupling circuitry 104 is arranged downstream of the connector 202 and includes (a) a power decoupling circuitry 204 (e.g., including an inductor) to decouple power from the PoDL line 112, which decoupled power is transmitted to the energy management system 106, and (a) a data interface 206 to decouple data from the PoDL line 112, which decoupled data is transmitted to a data connection of the application circuitry 102. The data interface 206 may comprise circuitry to block power from being transmitted to application circuitry 102.

The energy management system 106 includes the energy storage device 110, current limiter circuitry 130, and a power control circuitry 210. The power control circuitry 210 includes circuitry to selectively enable and disable the switchable power supply 122, for example based on a control signal 214 (e.g., an inhibit signal INH) from the application circuitry 102 corresponding with the operational mode (sleep mode versus active mode) of the application circuitry 102. The application circuitry 102 may include a functional device 220, e.g., a sensor or an actuator.

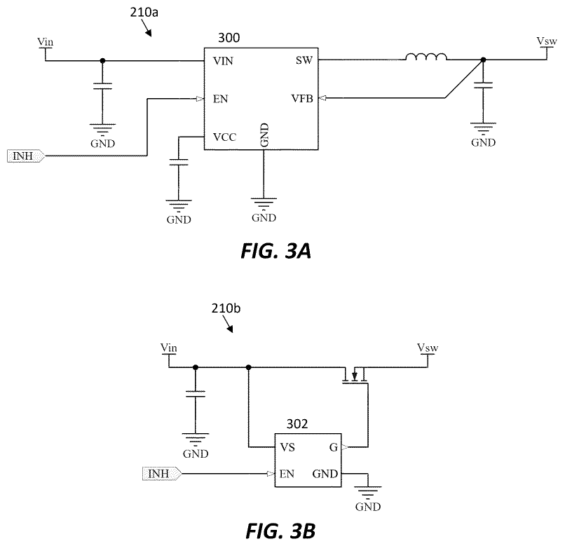

In some examples, as shown in FIG. 3A, the power control circuitry 210 may comprise a “voltage regulator with enable function” circuit 210a including a voltage regulator 300. In other examples, as shown in FIG. 3B, the power control circuitry 210 may comprise a “high side switch” circuit 210b including a high side driver 302. It should be understood that circuits 210a and 210b are examples only; power control circuitry 210 may comprise any other suitable circuitry in other examples.

FIG. 4 shows an example apparatus 400 including the application circuitry 102 switchable between a sleep mode and an active mode, and circuitry for controllably supplying power to the application circuitry 102. The example apparatus 400 may comprise an example implementation of the example apparatus 100 shown in FIG. 1 and discussed above. In some examples, the apparatus 400 may be a network node in a PoDL network.

As shown, the example apparatus 400 includes connector 202, power/data decoupling circuitry 104 including power decoupling circuitry 204 and data interface 206, application circuitry 102, and energy management system 106.

In this example, application circuitry 102 may include a network interface 402, a processor 404, and functional device 220. The network interface 402 may comprise an Ethernet controller or other network interface. The processor 404 may be embodied in a microcontroller or may otherwise comprise a microprocessor, FPGA, or other processor. As mentioned above, the functional device 220 may comprise a sensor, an actuator, or other functional device. In some examples, the network interface 402 may remain in a low-power state during sleep mode operation of application circuitry 102, whereas the processor 404 and functional device 220 may fully power-off during sleep mode operation, and may be awakened by the network interface 402 for active mode operation. Thus, as shown in FIG. 4, the network interface 402 may be powered by the continuous power supply 120 (V_{cont}) (which maintains the network interface 402 in the low-power state during the sleep mode of application circuitry 102) and the switchable power supply 122 (V_{sw}) (for active mode operation), whereas the processor 404 and functional device 220 may be powered by the switchable power supply 122 (V_{sw}) (for active mode operation) but not by the continuous power supply 120 (V_{cont}) (allowing the processor 404 and functional device 220 to fully power off during sleep mode operation).

The energy management system 106 may include energy storage device 110, current limiter circuitry 130, a power control circuitry 210, and a control circuitry 410. The control circuitry 410 may comprise circuitry to generate and transmit control signals to application circuitry 102 (e.g., the network interface 402) to initiate a respective instance of active mode operation (along with enabling the switchable power supply 122).

As shown, control circuitry 410 may include either one of, or both of, a comparator 412 or a timer 414. The comparator 412 may comprise circuitry to compare a voltage V_{stored_energy} of the energy storage device 110 (corresponding with a charge level of the energy storage device 110) with a threshold voltage V_{charged}, e.g., corresponding with the charge level sufficient to power the application (via the switchable power supply 122) for an instance of active mode operation. When the comparator V_{stored_energy} exceeds V_{charged}, the comparator 412 may output a control signal 416 to the application circuitry 102.

In the illustrated example, the comparator 412 transmits the control signal 416 to the network interface 402. In response to receiving the control signal 416, the network interface 402 may (a) initiate an activation of the switchable power supply 122, e.g., by sending an inhibit signal 214 to power control circuitry 210, which may enable the switchable power supply 122 to supply power to application circuitry 102 (including the network interface 402, processor 404, and functional device 220), and (b) generate and transmit respective wake signals to awaken the network interface 402, processor 404, and functional device 220.

The timer 414 (which may be provided in addition to, or alternative to, the comparator 412) may comprise circuitry to generate a control signal 416 at a defined frequency, e.g., every second or every 10 seconds. Some examples include a comparator 412 and timer 414, for example wherein the timer 414 sends a signal to the comparator 412 at a defined frequency (e.g., every second or every 10 seconds), upon which the comparator 412 transmits a control signal 416 to application circuitry 102 if V_{stored_energy}>V_{charged}, and otherwise waits until V_{stored_energy}>V_{charged} before transmitting the control signal 416.

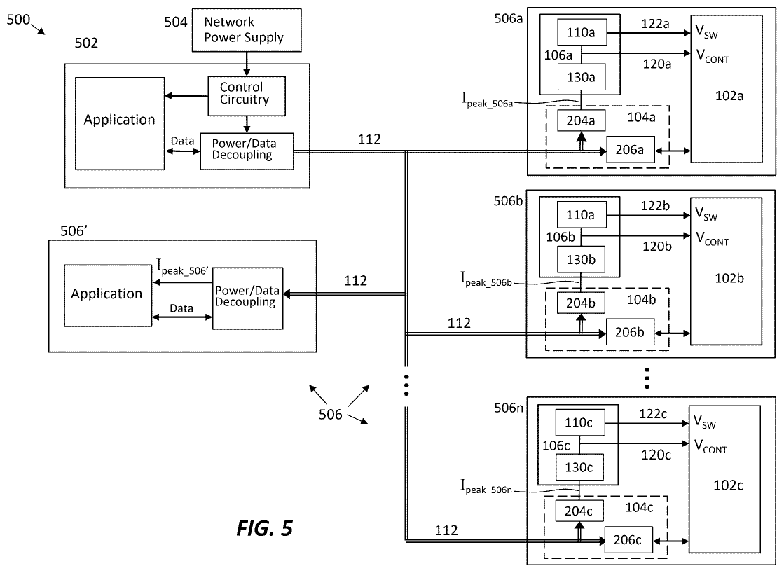

FIG. 5 shows an example PoDL network 500 incorporating aspects of the present disclosure. For example, the PoDL network 500 may include (a) a power source device, e.g., a Power Sourcing Equipment (PSE) node 502 including or connected to a network power supply 504 and (b) multiple powered devices, e.g., multiple Powered Device (PD) nodes 506 connected to the PSE node 502 by a PoDL line 112. In one example, the example PoDL network 500 may be implemented in a 10BASE-T1S Ethernet network, wherein all nodes are physically connected to the same PoDL cable, thus referred to as a “multidrop network.”

As shown, the PSE node 502 may include, for example, an application circuitry, control circuitry, and power/data decoupling circuitry, e.g., as generally known in the art.

PD nodes 506 may include (a) at least one node, indicated at 506a-506n, that stores energy collected from the PoDL line 112 in a respective energy storage device 110a-110n and intermittently uses such stored energy for providing a respective switchable power supply 122a-122n for active mode operation of a respective application circuitry 102a-102n and operationally (b) at least one node 506′, e.g., at least one conventional node that does not store energy collected from the PoDL line 112, but rather powers a respective application directly from the PoDL line 112.

Respective PD nodes 506a-506n may correspond with any of the example apparatuses 100, 200, or 400 discussed above. Accordingly, a respective PD node 506a-506n may include a respective application circuitry 102a-102n, respective power/data decoupling circuitry 104a-104n (e.g., including respective power decoupling circuitry 204a-204n and respective data interface 206a-206n as discussed above), and a respective energy management system 106a-106n (e.g., including respective current limiter circuitry 130a-130n and a respective energy storage device 110a-110n as discussed above) to provide the respective continuous power supply 120a-120n and respective switchable power supply 122a-122n to the respective application circuitry 102a-102n as a function of the current operational mode (e.g., sleep mode or active mode) of the respective application circuitry 102a-102n, as discussed above.

As discussed above regarding example apparatuses 100, 200, and 400, respective PD nodes 506a-506n (which may respectively correspond with apparatus 100, 200, or 400) may draw a respective peak PoDL current draw (I_{peak_506a}-I_{peak_506n}) from the PoDL line 112 (e.g., as defined by the respective current limiter circuitry 130) that is less than the current needed for active mode operation of the respective application circuitry 102a-102n (I_{active_102a}-I_{active_102n}). For example, I_{peak_506a} drawn by PD node 506a may be less than 50% of I_{active}, less than 10% of I_{active}, or less than 1% of I_{active_102a}. As a result, the current carried on the PoDL line 112 (I_{PoDL}) provided by the network power supply 504 may be reduced, e.g., as compared with a conventional system consisting of conventional PD nodes 506′ that do not provide energy storage for reducing Iₚₑₐₖ as disclosed herein.

Reducing I_{PoDL} may provide various different advantages or benefits. For example, reducing I_{PoDL} may reduce the size and cost of the network power supply 504. As another example, reducing I_{PoDL} may allow reduction and/or simplification of various components in network 500, for example including respective power/data decoupling circuitry 104a-104n of respective PD nodes 506a-506n, along with respective power/data decoupling circuitry of conventional PD nodes 506′ and PSE node 502. In addition, reducing I_{PoDL} may allow reductions in wiring/cabling requirements (e.g., wire gauge) and unwanted heat generation. As another example, reducing I_{PoDL} may allow long cable lengths between network nodes 502, 506a-506n and/or 506′, and may allow for a larger number of PD nodes 506a-506n and/or 506′ in the network 500. As yet another example, reducing I_{PoDL} may reduce power-related effects on (and thereby improve) the signal quality of data transmitted over PoDL line 112 and/or data transmitted to respective application circuitries of nodes 502, 506′ and 506a-506n (e.g., including respective application circuitries 102a-102n).

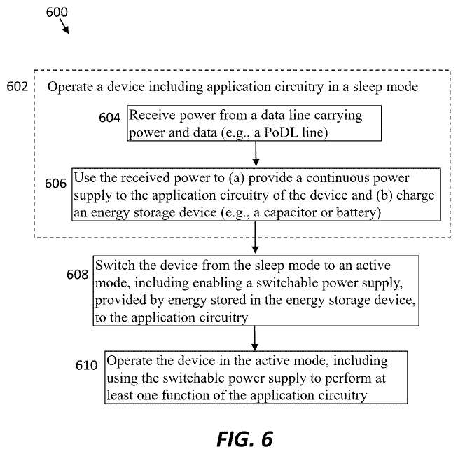

FIG. 6 shows a flowchart of an example method 600 of operating a device (e.g., apparatus 100, 200, or 400 discussed above) including an application circuitry (e.g., including a sensor, actuator, or other functional device) switchable between a sleep mode and an active mode, and circuitry for storing energy and controllably supplying power to the application circuitry. At 602, the device is operated in a sleep mode (e.g., a low-power mode). Operating the device in the sleep mode at 602 may include (a) at 604, receiving power from a data line carrying power and data (e.g., a PoDL line) and (b) at 606, using the received power to (a) provide a continuous power supply to the application circuitry and (b) charge an energy storage device.

At 608, the device is switched from the sleep mode to an active mode, which includes enabling a switchable power supply, provided by energy stored in the energy storage device, to the application circuitry. At 610, the device is operated in the active mode, including using the switchable power supply (provided by energy stored in the energy storage device) to perform at least one function of the application circuitry.

Although example embodiments have been described above, other variations and embodiments may be made from this disclosure without departing from the spirit and scope of these embodiments.

1. An apparatus, comprising:
a power/data decoupling circuitry connected to a data line carrying power and data, the power/data decoupling circuitry to decouple power from data carried on the data line;
an application circuitry switchable between a sleep mode and an active mode; and
an energy management system including an energy storage device connected between the power/data decoupling circuitry and the application circuitry;
wherein the energy management system includes circuitry to:
receive power from the power/data decoupling circuitry;
use the received power to (a) provide a continuous power supply to the application circuitry in at least the sleep mode of the application circuitry and (b) charge the energy storage device; and
use energy stored in the energy storage device to provide a switchable power supply to the application circuitry in at least the active mode of the application circuitry.

2. The apparatus of claim 1, wherein the energy management system includes a current limiter circuitry connected between the power/data decoupling circuitry and the energy storage device, the current limiter circuitry to limit a current drawn from the data line.

3. The apparatus of claim 2, wherein a current output by the current limiter circuitry (a) supplies the continuous power supply to the application circuitry and (b) charges the energy storage device.

4. The apparatus of claim 1, wherein the energy management system provides the continuous power supply to the application circuitry in both the sleep mode and the active mode of the application circuitry.

5. The apparatus of claim 1, wherein the energy storage device comprises a capacitor or a battery.

6. The apparatus of claim 1, comprising control circuitry to:
selectively switch the application circuitry between the sleep mode and the active mode;
enable the switchable power supply, provided by energy stored in the energy storage device, to the application circuitry for operation in the active mode of the application circuitry; and
disable the switchable power supply from the application circuitry for operation in the sleep mode of the application circuitry.

7. The apparatus of claim 6, wherein the control circuitry comprises a comparator to:
compare a charge level of the energy storage device with a threshold charge level; and
based on the comparison, generate an activation signal to (a) switch the application circuitry from the sleep mode to the active mode and (b) enable the switchable power supply to the application circuitry.

8. The apparatus of claim 6, wherein the control circuitry comprises a timer circuitry to generate a time-based activation signal to (a) switch the application circuitry from the sleep mode to the active mode and (b) enable the switchable power supply to the application circuitry.

9. The apparatus of claim 1, wherein a current drawn from the data line by the energy management system is lower than a current used by the application circuitry in the active mode of the application circuitry.

10. The apparatus of claim 1, wherein:
the application circuitry comprises an network controller and a functional device;
in the sleep mode of the application circuitry, the network controller is powered by the continuous power supply, and the functional device is unpowered; and
in the active mode of the application circuitry, the network controller and the functional device are powered by the switchable power supply from the energy storage device.

11. An apparatus, comprising:
a power source device; and
multiple powered devices connected to the power source device by a data line carrying power and data;
wherein a respective powered device of the multiple powered devices comprises:
a power/data decoupling circuitry to decouple power from data carried on the data line;
an application circuitry switchable between a sleep mode and an active mode; and
an energy management system including an energy storage device connected between the power/data decoupling circuitry and the application circuitry;
wherein the energy management system includes circuitry to:
receive power from the power/data decoupling circuitry;
use the received power to (a) provide a continuous power supply to the application circuitry in at least the sleep mode of the application circuitry and (b) charge the energy storage device; and
use energy stored in the energy storage device to provide a switchable power supply to the application circuitry in at least the active mode of the application circuitry.

12. The apparatus of claim 11, wherein the energy management system of the respective powered device includes a current limiter circuitry connected between the power/data decoupling circuitry and the energy storage device, the current limiter circuitry to limit a current drawn from the data line.

13. The apparatus of claim 12, wherein an output of the current limiter circuitry (a) supplies the continuous power supply to the application circuitry and (b) charges the energy storage device.

14. The apparatus of claim 11, the respective powered device includes control circuitry to:
selectively switch the application circuitry between the sleep mode and the active mode;
enable the switchable power supply, provided by energy stored in the energy storage device, to the application circuitry for operation in the active mode of the application circuitry; and
disable the switchable power supply from the application circuitry for operation in the sleep mode of the application circuitry.

15. The apparatus of claim 14, wherein the control circuitry comprises a comparator to:
compare a charge level of the energy storage device with a threshold charge level; and
based on the comparison, generate an activation signal to (a) switch the application circuitry from the sleep mode to the active mode and (b) enable the switchable power supply to the application circuitry.

16. The apparatus of claim 14, wherein the control circuitry comprises a timer circuitry to generate a time-based activation signal to (a) switch the application circuitry from the sleep mode to the active mode and (b) enable the switchable power supply to the application circuitry.

17. A method, comprising:
operating a device including application circuitry in a sleep mode, including:
receiving power from a data line carrying power and data;
using the received power to:
provide a continuous power supply to the application circuitry; and
charge an energy storage device;
switching the device from the sleep mode to an active mode, including enabling a switchable power supply, provided by energy stored in the energy storage device, to the application circuitry; and
operating the device in the active mode, including using the switchable power supply to perform at least one function of the application circuitry.

18. The method of claim 17, wherein receiving power from a data line in the sleep mode comprises:
using a power/data decoupling circuitry to decouple power from data carried on the data line; and
using a current limiter circuitry to limit a current drawn from the data line.

19. The method of claim 17, comprising:
using a comparator circuitry to compare a charge level of the energy storage device with a threshold charge level; and
based on the comparison, generating an activation signal to (a) switch the device from the sleep mode to the active mode and (b) enable the switchable power supply to the application circuitry.

20. The method of claim 17, comprising using a timer circuitry to generate a time-based activation signal to (a) switch the device from the sleep mode to the active mode and (b) enable the switchable power supply to the application circuitry.
